(19) United States
(12) Patent Application Publication
(10) Pub. No.: US 2021/0109850 A1
(43) Pub. Date: Apr. 15, 2021

(54) PROCESSING SYSTEM AND EXECUTE IN PLACE CONTROL METHOD

(71) Applicant: REALTEK SEMICONDUCTOR CORPORATION, HSINCHU (TW)

(72) Inventor: YUE-FENG CHEN, Suzhou (CN)

(21) Appl. No.: 17/018,024

(22) Filed: Sep. 11, 2020

(30) Foreign Application Priority Data
Oct. 15, 2019 (CN) 201910978172.9

(51) Int. Cl. G06F 12/02

(52) U.S. Cl. CPC G06F 12/0215

(57) ABSTRACT

A processing system includes a memory, a processor circuit, and an execute-In-Place (XIP) controller circuit. The processor circuit is configured to output a command The XIP controller circuit is configured to determine a predicted address of the memory to be read by a next operation of the processor circuit in response to the command, in order to prefetch data from the memory according to the predicted address.

### BACKGROUND OF THE INVENTION

1. Field of the Invention

The present disclosure relates to a processing system, especially to a processing system having a function of execute in place and a control method thereof.

2. Description of Related Art

In computer systems, a mechanism of execute-in-place allows a processor to directly read data or execute a program from a normal data storage memory (e.g., a long-term storage memory and a flash memory) without copying the data or the program to a random access memory in advance. However, in current approaches, the performance of the computer system is limited by delay of practical circuit operations and/or transmission delay of practical wires.

### SUMMARY OF THE INVENTION

In some embodiments, a processing system includes a memory, a processor circuit, and an execute-In-Place (XIP) controller circuit. The processor circuit is configured to output a command The XIP controller circuit is configured to determine a predicted address of the memory to be read by a next operation of the processor circuit in response to the command, in order to prefetch data from the memory according to the predicted address.

In some embodiments, a XIP control method includes the following operations: acquiring a first memory address to be read by a processor circuit according to a command outputted from the processor circuit; searching an address lookup table according to the first memory address, in order to output a matched address; acquiring a program to be executed by the processor circuit according to the command, and decoding the program to output a jump address; generating a forecast address according to a predetermined value and the first memory address; outputting one of the matched address, the jump address, and the forecast address as an estimated address, and outputting the estimated address as a predicted address; and prefetching a data from a memory according to the predicted address for the processor circuit.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a schematic diagram of a processing system according to some embodiments of the present disclosure.

FIG. 2 illustrates a circuit diagram of the execute-in-place (XIP) controller circuit in FIG. 1 according to some embodiments of the present disclosure.

FIG. 3 illustrates a flow chart of a XIP control method according to some embodiments of the present disclosure.

FIG. 4 illustrates a flow chart of one operation in FIG. 3 according to some embodiments of the present disclosure.

FIG. 5 illustrates a circuit diagram of the XIP controller circuit in FIG. 1 according to some embodiments of the present disclosure.

FIG. 6 illustrates a circuit diagram of the XIP controller circuit in FIG. 1 according to some embodiments of the present disclosure.

### DETAILED DESCRIPTION OF THE PREFERRED EMBODIMENTS

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

In this document, the term “circuit” may indicate an object, which is formed with one or more transistors and/or one or more active/passive elements based on a specific arrangement, for processing signals. As used herein, the term “and/or” includes any and all combinations of one or more of the associated listed items.

Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments.

For ease of understanding, like elements in various figures are designated with the same reference numbers.

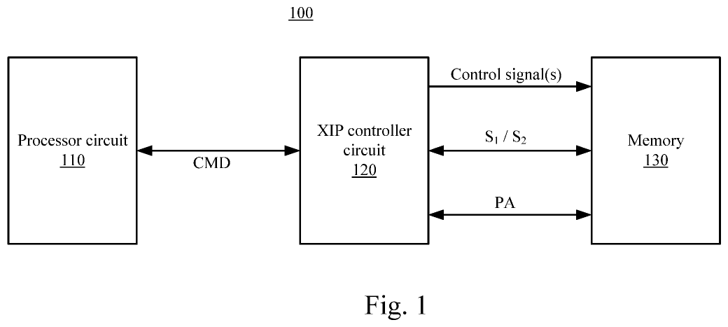

FIG. 1 illustrates a schematic diagram of a processing system 100 according to some embodiments of the present disclosure. In some embodiments, the processing system 100 may be applied to an electronic device having a function of eXecute-In-Place (XIP), in order to improve an efficiency of executing programs.

The processing system 100 includes a processor circuit 110, a XIP controller circuit 120, and a memory 130. The processor circuit 110 is configured to output a command CMD, in order to notify the XIP controller circuit 120 of which data S₁ is going to be read and/or which program S₂ is going to be executed. The XIP controller circuit 120 is coupled between the processor circuit 110 and the memory 130. The XIP controller circuit 120 is configured to determine a predicted address PA of the memory 130 to be read in a next operation of the processor circuit 110 according to the command CMD, and to prefetch the data S₁ from the memory 130 according to the predicted address PA. In the next operation, the processor circuit 110 is able to read the data S₁ from the XIP controller circuit 120. As a result, impact(s) from circuit delay and data transmission delay can be reduced, in order to increase the efficiency of the processor circuit 110 in executing instructions. In some embodiments, the XIP controller circuit 120 may output one or more control signals to the memory 130, in order to perform data read/write operations.

In some embodiments, the memory 130 may be a flash memory. In some embodiments, the memory 130 may be an electrically-erasable programmable read-only memory (EEPROM). The types of the memory 130 are given for illustrative purposes, and the present disclosure is not limited thereto. Various types of the memory 130 are within the contemplated scope of the present disclosure.

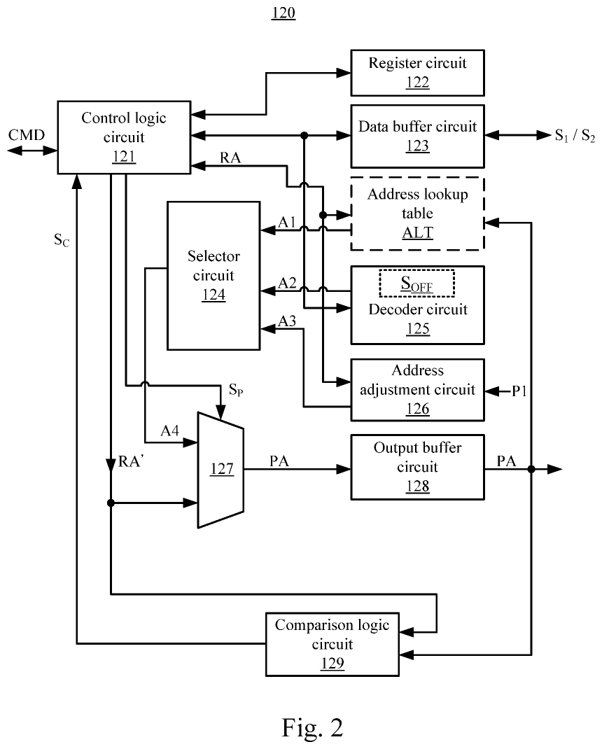

In some embodiments, the XIP controller circuit 120 is able to utilize a lookup table (e.g., an address lookup table ALT in FIG. 2) to determine the predicted address PA according to the command CMD. In some embodiments, the lookup table may be preset and stored in the XIP controller circuit 120. In some embodiments, the processor circuit 110 is able to build and dynamically update the lookup table with the XIP controller circuit 120. In some embodiments, the XIP controller circuit 120 determines a jump address generated in response to the command CMD, and outputs the jump address as the predicted address PA. In some embodiments, when the processor circuit 110 outputs an new the command CMD and an memory address which is going to be read by this new command CMD is different from the current predicted address PA, the XIP controller circuit 120 stops the prefetch operation that is performed based on the current predicted address PA. Certain embodiments of the XIP controller circuit 120 are given with reference to the following FIG. 2.

FIG. 2 illustrates a circuit diagram of the XIP controller circuit 120 in FIG. 1 according to some embodiments of the present disclosure.

In some embodiments, the XIP controller circuit 120 includes the address lookup table ALT, a control logic circuit 121, a register circuit 122, a data buffer circuit 123, a selector circuit 124, a decoder circuit 125, an address adjustment circuit 126, a multiplexer circuit 127, an output buffer circuit 128, and a comparison logic circuit 129.

The control logic circuit 121 is configured to control various circuits according to the command CMD, in order to perform the prefetch operation. The register circuit 122 is configured to store one or more control parameters (not shown), and the control parameters are to set one or more systematic parameters of the XIP controller circuit 120, in order to perform the prefetch operation. In some embodiments, the register circuit 122 may be utilized to store at least part of the address lookup table ALT. The data buffer circuit 123 is a data buffer zone for temporarily storing the data S i transmitted from the memory 130.

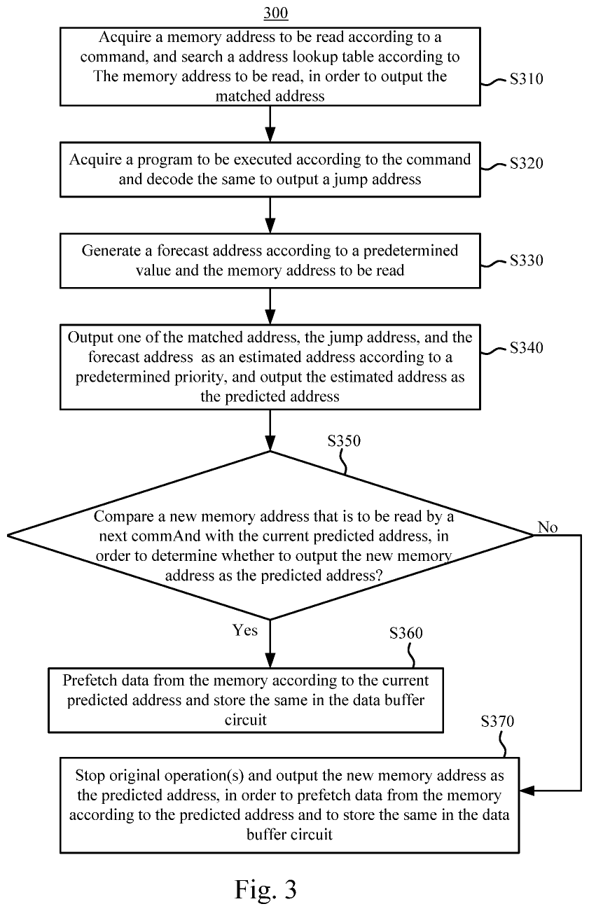

For ease of understanding, reference is made to both of FIG. 2 and FIG. 3, and FIG. 3 illustrates a flow chart of a XIP control method 300 according to some embodiments of the present disclosure. In some embodiments, the XIP control method 300 may be performed by the XIP controller circuit 120 in FIG. 2. In some embodiments, the control logic circuit 121 may be implemented with a state machine, a digital signal processor circuit, and/or a micro controller circuit that performs the XIP control method 300.

In operation S310, a memory address to be read is acquired according to a command, and the address lookup table is searched according to the memory address to be read, in order to output a matched address.

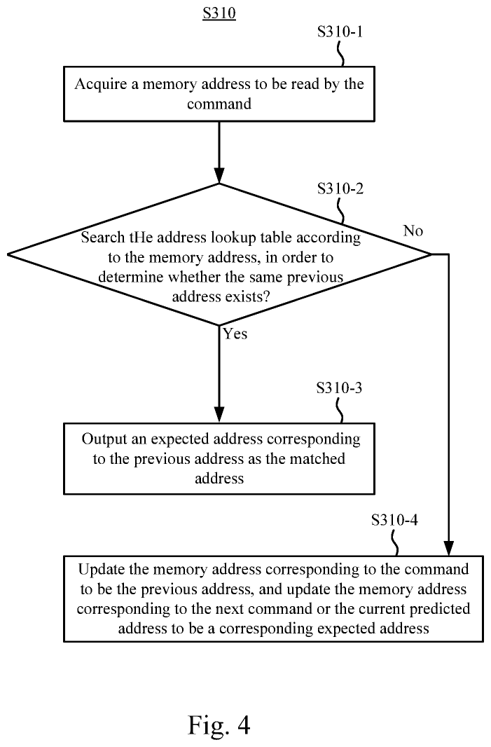

For example, the control logic circuit 121 is configured to acquire a memory address RA that is going to be read by the processor circuit 110 according to the command CMD, and to search the address lookup table ALT according to the memory address RA, in order to determine whether a matched address A1 exists in the address lookup table ALT. If the matched address A1 is stored in the address lookup table ALT, the control logic circuit 121 transmits the matched address A1 to the selector circuit 124. Alternatively, if the matched address A1 is not stored in the address lookup table ALT, the memory address RA is updated to the address lookup table ALT (e.g., operation S310-4 in FIG. 4).

In operation S320, a program to be executed is acquired according to the command and is decoded to output a jump address.

For example, the control logic circuit 121 is configured to determine that the processor circuit 110 is going to execute the program S₂ according to a fetch ID of the command CMD, the control logic circuit 121 is able to enable the decoder circuit 125 and to prefetch an instruction (or an instruction set) of the program S₂ from the memory 130. Accordingly the decoder circuit 125 is able to decode the program S₂. After the program S₂ is decoded, if the decoder circuit 125 acquires that the program S₂ includes a jump instruction, the decoder circuit 125 determines an offset value S_{OFF} according to this jump instruction, and determines a jump address A2 according to the memory address RA to be read (e.g., a memory address where the program S₂ is stored) and the offset value S_{OFF}.

In some embodiments, the jump instruction may be a jal instruction under the architecture of RSIC-V. For example, the jump instruction may be expressed as: J jal:instruction bit[6:0]==7′b1101111, and the instruction thereof is assumed to be 32′h9000_006f. According to the current encoding format of instructions, the decoder circuit 125 is able to determine that the offset value S_{OFF} is 32′hfff0_0100. As a result, the decoder circuit 125 sums up the memory address RA and the offset value S_{OFF} as the jump address A2, and outputs the jump address A2 to the selector circuit 124.

In some embodiments, if the processing system 100 is applied with an advanced extensible interface (AXI) protocol, the aforementioned fetch ID may be an AXI read address ID (ARID). The types of the instructions and those of protocols given above are for illustrative purposes, and the present disclosure is limited thereto.

With continued reference to FIG. 3, in operation S330, a forecast address is generated according to a predetermined value and the memory address to be read.

For example, after the memory address RA is acquired, the control logic circuit 121 transmits the memory address RA to the address adjustment circuit 126. The address adjustment circuit 126 sums up a predetermined value P1 and the memory address RA as a forecast address A3 and outputs the forecast address A3 to the selector circuit 124. In some embodiments, the forecast address A3 and the memory address RA are continuous memory addresses. For example, the forecast address A3 is a next memory address of the memory address RA. In some embodiments, the predetermined value P1 may be a bandwidth of one burst data. For example, if the predetermined value P1 is 32-bit and a burst length is 8, the address adjustment circuit 126 is able to sum up the memory address RA and 32, in order to generate the forecast address A3.

In operation S340, one of the matched address, the jump address, and the forecast address is outputted as an estimated address according to a predetermined priority, and the estimated address is outputted as the predicted address.

In some embodiments, the selector circuit 124 outputs one of the matched address A1, the jump address A2, and the forecast address A3 as an estimated address A4 according to the predetermined priority, and transmits the estimated address A4 to the multiplexer circuit 127. In some embodiments, matched address A1 or the jump address A2 is given priority to be outputted as the estimated address A4. For example, the predetermined priority may be set in a sequence of the matched address A1, the jump address A2, and the forecast address A3. In other words, if the matched address A1 exists, the selector circuit 124 outputs matched address A1 as the estimated address A4 with a top priority; if the matched address A1 is non-existent and the jump address A2 exists, the selector circuit 124 outputs the jump address A2 as the estimated address A4; and if both of the matched address A1 and the jump address A2 are non-existent, the selector circuit 124 outputs the forecast address A3 as the estimated address A4. In some other embodiments, the predetermined priority may be set in a sequence of the jump address A2, the matched address A1, and the forecast address A3.

In some embodiments, in response to the current command CMD, the multiplexer circuit 127 is configured to output the estimated address A4 as the predicted address PA, and to transmit the predicted address PA to the output buffer circuit 128. The output buffer circuit 128 may be implemented with one or more registers, in order to temporarily store the predicted address PA.

In operation S350, a new memory address that is to be read by a next command is compared with the current predicted address, in order to determine whether to output the new memory address as the predicted address. If the new memory address is determined to be outputted as the predicted address, operation S360 is performed. Alternatively, if the new memory address is not determined to be outputted as the predicted address, operation S370 is performed.

In operation S360, data is prefetched from the memory according to the current predicted address and is stored in the data buffer circuit.

In operation S370, original operation is stopped, and the new memory address is outputted as the predicted address, in order to prefetch data from the memory according to the predicted address and to store the same in the data buffer circuit.

For example, in a progress of performing operations S310 to S340, if the processor circuit 110 outputs a new command CMD and the control logic circuit 121 acquires a new memory address RA′ that is going to be read by this new command CMD, the control logic circuit 121 outputs this new memory address RA′ to the comparison logic circuit 129 and the multiplexer circuit 127. The comparison logic circuit 129 reads the current predicted address PA from the output buffer circuit 128, and compares the predicted address PA with the new memory address RA′, in order to output a control signal S_{C}. If the predicted address PA is the same as the new memory address RA′, the control logic circuit 121 keeps a value of a selection signal S_{P} fixed in response to the control signal S_{C}. Under this condition, the multiplexer circuit 127 still outputs the estimated address A4 as the predicted address PA. Accordingly, the control logic circuit 121 acquires the data S₁ from the memory 130 according to the predicted address PA (i.e., the estimated address A4), and stores the data S₁ to the data buffer circuit 123. Alternatively, if the predicted address PA is different from the new memory address RA′, the control logic circuit 121 adjusts the value of the selection signal S_{P} in response to the control signal S_{C} and stops current operations of other circuits. Under this condition, the multiplexer circuit 127 outputs the new memory address RA′ as the predicted address PA. Accordingly, the control logic circuit 121 acquires the data S₁ from the memory 130 according to the predicted address PA (i.e., the new memory address RA′) and stores the data S₁ to the data buffer circuit 123.

With the above operations, the XIP controller circuit 120 is able to forecast data required by a next operation of the processor circuit 110 according to the command CMD, and is able to prefetch the data from the memory 130. In the next operation, the processor circuit 110 is able to directly access the data previously stored in the XIP controller circuit 120 rather than in the memory 130. As a result, impacts from a transmission delay between the processor circuit 110 and the memory 130 can be prevented, and thus the performance of overall system can be improved.

In FIG. 2, the XIP controller circuit 120 is able to perform multiple operations (e.g., operations S310, S320, and S330) according to the memory address RA to be read by the command CMD, in order determine multiple addresses that may be going to be read (i.e., the matched address A1, the jump address A2, and the forecast address A3) to generate the predicted address PA. It should be understood that, in different embodiments, the XIP controller circuit 120 is able to perform at least one of operations S310, S320, or S330, in order to determine at least one of the matched address A1, the jump address A2, or the forecast address A3 to generate the predicted address PA. In other words, one or more operations in the above embodiments can be combined according to requirements of practical applications, and thus the present disclosure is not limited by embodiments of FIG. 2.

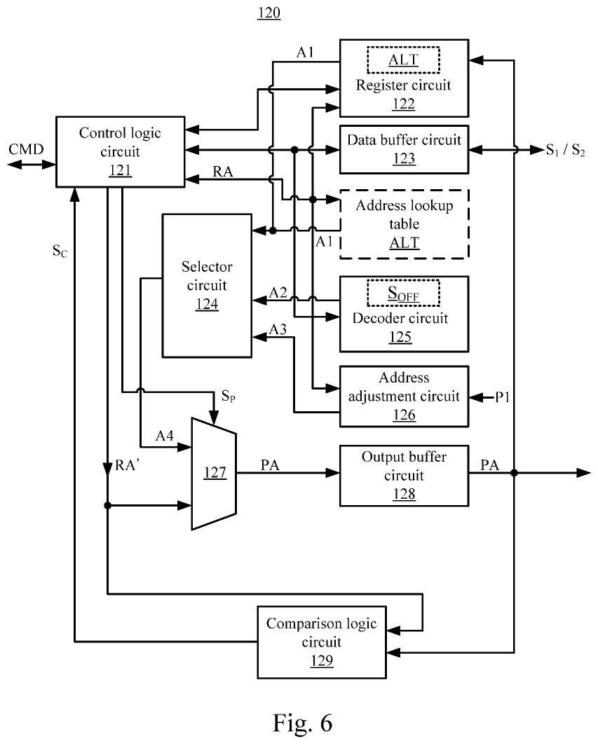

In some embodiments, a first portion of the address lookup table ALT may be stored in the register circuit 122, and a second portion of the address lookup table ALT may be stored in an independent register circuit (as shown in FIG. 6), in which a content of the first portion (e.g., entry 1 in the table below) is immutable, and a content of the second portion (e.g., entry 2 in the table below) is able to be updated by the processor circuit 110 via the XIP controller circuit 120.

For example, the address lookup table ALT may be expressed as the following table:

| | | auto | previous | expected |
|---|---|---|---|---|
| entry | state | update | address | address |
| 1 | valid | Not applicable | first address | second address (e.g., A1) |
| 2 | valid | Applicable | third address | fourth address |
| | | | (after being | (after being |
| | | | updated) | updated) |
| . | . | . | . | . |
| . | . | . | . | . |
| . | . | . | . | . |

For ease of understanding, reference is made to FIG. 4, and FIG. 4 illustrates a flow chart of operation S310 in FIG. 3 according to some embodiments of the present disclosure. Operation S310 includes steps S310-1 to S310-4, and these steps are described with reference to the above table.

In step S310-1, a memory address to be read by the command is acquired. For example, the command CMD is a read command, and the memory address RA indicates a location of the memory 130 where the data to be read by this read command is stored. The control logic circuit 121 is able to acquire information of the memory address RA according to the command CMD.

In step S310-2, the address lookup table is searched according to the memory address, in order to determine whether the same previous address exists. If the same previous address exists, step S310-3 is performed; alternatively, if the same previous address does not exist, step S310-4 is performed.

In step S310-3, an expected address corresponding to the previous address is outputted as the matched address.

In step S310-4, the memory address corresponding to the command is updated to be the previous address, and the memory address corresponding to the next command or the current predicted address is updated to be a corresponding expected address.

For example, if the control logic circuit 121 acquires that the memory address RA is a first address according to the command CMD, the control logic circuit 121 searches the address lookup table ALT according to the memory address RA, and determines that the memory address RA is the same as the first address of the entry 1. Under this condition, the control logic circuit 121 outputs the expected address of the entry 1 (i.e., a second address) as the matched address A1.

Alternatively, if the control logic circuit 121 determines that the memory address RA is different from all previous addresses in the address lookup table ALT, the control logic circuit 121 updates the memory address RA to be the previous address of one entry in the address lookup table ALT, and updates the memory address RA corresponding to the next command CMD (or the current predicted address PA) to be the expected address of the same entry. In some embodiments, the control logic circuit 121 may update the address lookup table ALT according to a policy of least recently used (LRU), round robin, or the like.

For example, the memory address RA corresponding to a first command CMD is a third address, and the memory address RA corresponding to a second command CMD is a fourth address. If the third address is not the same as the previous addresses of the address lookup table ALT and is different from the fourth address, the control logic circuit 121 updates this third address to be the previous address of entry 2, and updates the fourth address to be the expected address for subsequent operations.

Alternatively, the memory address RA corresponding to the current command CMD is the third address and is not the same as the previous addresses of the address lookup table ALT. If the multiplexer circuit 127 outputs the predicted address PA (e.g., the fourth address) in response to the current command CMD and the predicted address PA is different from the memory address RA, the control logic circuit 121 updates the third address to be the previous address of entry 2, and updates the fourth address to the expected address of entry 2 for subsequent operations.

In some embodiments, when the predicted address PA and the memory address RA are successive memory addresses (for example, when the predicted address PA is the same as the forecast address A3), the control logic circuit 121 does not update the address lookup table ALT.

The above description of the XIP control method 300 and that of step S310 include exemplary operations, but the operations of the XIP control method 300 are not necessarily performed in the order described above. The order of the operations of the XIP control method 300 can be changed, or the operations can be executed simultaneously or partially simultaneously as appropriate, in accordance with the spirit and scope of various embodiments of the present disclosure.

In some embodiments, the previous address and the expected address of the same entry are configured to be an address pair. In some embodiments, various address pairs can be determined in advance through computer simulations, and can be pre-stored in register(s) of the XIP controller circuit 120 (which may be, but not limited to, the register circuit 122).

In some embodiments, an initial state of the address lookup table ALT can be set as invalid. In some embodiments, with the XIP controller circuit 120, the processor circuit 110 is able to build various address pairs into the address lookup table ALT, and to update the state of each entry to be valid. In some embodiments, when a field of “auto update” for one entry (e.g., entry 1) in the address lookup table ALT is set to be not applicable, the information of this entry cannot be updated by the control logic circuit 121. Alternatively, when the field of “auto update” for one entry (e.g., entry 2) in the address lookup table ALT is set to be applicable, the information of this entry can be updated by the control logic circuit 121.

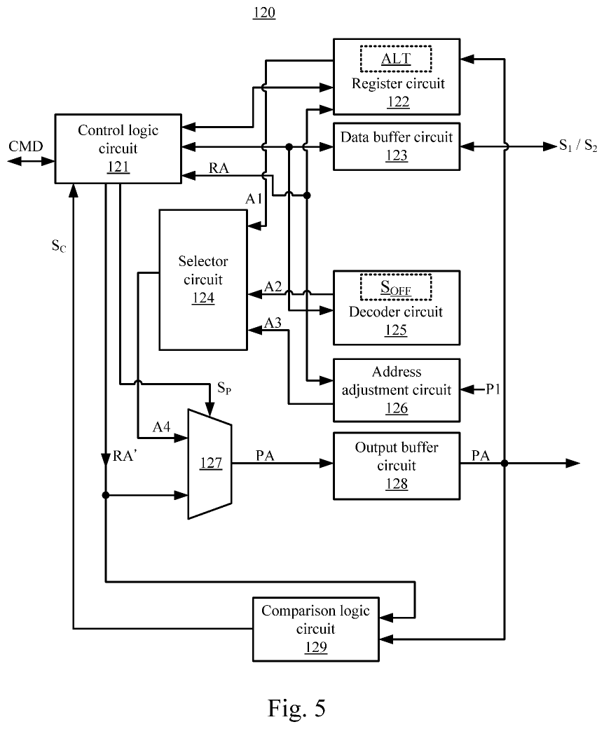

As shown in FIG. 2, in some embodiments, the address lookup table ALT may be stored in an independent register. FIG. 5 illustrates a circuit diagram of the XIP controller circuit 120 in FIG. 1 according to some embodiments of the present disclosure. Compared with FIG. 2, in this example, the address lookup table ALT is stored in the register circuit 122. Alternatively, reference is made to FIG. 6, and FIG. 6 illustrates a circuit diagram of the XIP controller circuit 120 in FIG. 1 according to some embodiments of the present disclosure. Compared with FIG. 2 or FIG. 5, in this example, a portion of the address lookup table ALT is stored in the register circuit 122, and another portion of the address lookup table ALT is stored in an independent register.

The above form and the above configurations of the address lookup table ALT are given for illustrative purposes, and the present disclosure is not limited thereto. The forms and the configurations of the address lookup table ALT may be adjusted or changed according to different applications.

As described above, the processing system and the XIP control method provided in some embodiments of the present disclosure are able to forecast data or command required by a next operation according to a command sent from a processor circuit, in order to prefetch the data or the command from a memory for the processor circuit. As a result, a transmission delay between the processor circuit and the memory can be reduced, and thus the efficiency of the processor circuit for executing command(s) can be improved.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely the preferred embodiments of the present disclosure, without any intention to limit the scope of the present disclosure thereto. Various equivalent changes, alterations, or modifications based on the claims of present disclosure are all consequently viewed as being embraced by the scope of the present disclosure.

What is claimed is:

1. A processing system, comprising:
a memory;
a processor circuit configured to output a command; and
an eXecute-In-Place (XIP) controller circuit configured to determine a predicted address of the memory to be read by a next operation of the processor circuit in response to the command, in order to prefetch data from the memory according to the predicted address.

2. The processing system of claim 1, wherein the XIP controller circuit is configured to acquire a first memory address to be read by the processor circuit according to the command, and to search an address lookup table according to the first memory address, in order to determine whether a matched address exists in the address lookup table to generate the predicted address.

3. The processing system of claim 2, wherein if the matched address does not exist in the address lookup table, the XIP controller circuit is configured to update the first memory address to the address lookup table and to update a second memory address to the address lookup table to be the matched address corresponding to the first memory address.

4. The processing system of claim 3, wherein the second memory is a memory address to be read by a next command outputted from the processor circuit, or is the predicted address that is determined by the XIP controller circuit in response to the command

5. The processing system of claim 1, wherein the XIP controller circuit is configured to acquire a program to be executed by the processor circuit according to the command, and to decode the program to determine a jump address, in order to determine the predicted address.

6. The processing system of claim 1, wherein the XIP controller circuit is configured to acquire a first memory address to be read by the processor circuit, and to generate a forecast address according to the first memory address and a predetermined value, in order to determine the predicted address.

7. The processing system of claim 6, wherein the first memory address and the forecast address are successive memory addresses.

8. The processing system of claim 1, wherein the XIP controller circuit is configured to determine a matched address, a jump address, and a forecast address according to the command, and to output one of the matched address, the jump address, and the forecast address as an estimated address, and to output the estimated address as the predicted address, wherein the matched address is determined according to the command and a lookup table, the jump address is determined by decoding a program according to the command, and the forecast address is a next memory address of a memory address to be read by the command

9. The processing system of claim 8, wherein the matched address or the jump address is given priority to be outputted as the estimated address.

10. The processing system of claim 1, wherein the XIP controller circuit is further configured to compare a new memory address with the predicted address, and if the new memory address is different from the predicted address, the XIP controller circuit outputs the new memory address as the predicted address, wherein the new memory address is a memory address to be read by a next command outputted from the processor circuit.

11. The processing system of claim 1, wherein the XIP controller circuit comprises:
a control logic circuit configured to acquire a first memory address according to the command and to search an address lookup table according to the first memory address, and to prefetch a program to be executed by the processor circuit from the memory;
a data buffer circuit configured to temporarily store the data or the program;
a decoder circuit configured to decode the program to determine a jump address;
an address adjustment circuit configured to sum up a predetermined value and the first memory address, in order to generate a forecast address;
a selector circuit configured to output one of the matched address, the jump address, and the forecast address according to a predetermined priority as an estimated address; and
a multiplexer circuit configured to output the estimated address as the predicted address according to a selection signal.

12. The processing system of claim 11, wherein the XIP controller circuit further comprises:
a comparison logic circuit configured to compare the predicted address with a second memory address, in order to output a control signal,
wherein the second memory address is a new memory address to be read by a next command outputted from the processor circuit, and if the predicted address is different from the second memory address, the control logic circuit is configured to adjust the selection signal in response to the control signal, in order to control the multiplexer circuit to output the second memory address as the predicted address.

13. An eXecute-In-Place (XIP) control method, comprising:
acquiring a first memory address to be read by a processor circuit according to a command outputted from the processor circuit;
searching an address lookup table according to the first memory address, in order to output a matched address;
acquiring a program to be executed by the processor circuit according to the command, and decoding the program to output a jump address;
generating a forecast address according to a predetermined value and the first memory address;
outputting one of the matched address, the jump address, and the forecast address as an estimated address, and outputting the estimated address as a predicted address; and
prefetching a data from a memory according to the predicted address for the processor circuit.

14. The XIP control method of claim 10, wherein searching the address lookup table according to the first memory address comprises:
determining whether a previous address, which is the same as the first memory address, exists in the address lookup table; and
if the previous address exists in the address lookup table, outputting an expected address corresponding to the previous address as the matched address.

15. The XIP control method of claim 14, further comprising:
if the previous address does not exist in the address lookup table, updating the first memory address to the address lookup table; and
updating a second memory address to the address lookup table to be the expected address corresponding to the first memory address, wherein the second memory address is the predicted address or a new memory address to be read by a next command outputted from the processor circuit.

16. The XIP control method of claim 13, wherein decoding the program to output the jump address comprises:
decoding the program to determine that the program comprises a jump instruction;
determining an offset value according to the jump instruction; and
summing up the first memory address and the offset value, in order to generate the jump address.

17. The XIP control method of claim 13, wherein generating the forecast address according to the predetermined value and the first memory address comprises:
summing up the predetermined value of the first memory address, in order to generate the forecast address, wherein the first memory address and the forecast address are successive memory addresses.

18. The XIP control method of claim 13, wherein the matched address or the jump address is given priority to be outputted as the predicted address.

19. The XIP control method of claim 13, further comprising:
comparing a new memory address with the predicted address; and
if the new memory address is different from the predicted address, outputting the new memory address as the predicted address,
wherein the new memory address is a memory address to be read by a next command outputted from the processor circuit.

20. The XIP control method of claim 19, further comprising:
if the new memory address is the same as the predicted address, prefetching the data according to the predicted address.
